(19) United States
(12) Patent Application Publication
(10) Pub. No.: US 2012/0028117 A1
(43) Pub. Date: Feb. 2, 2012

(54) FLUORINATED BINDER COMPOSITE MATERIALS AND CARBON NANOTUBES FOR POSITIVE ELECTRODES FOR LITHIUM BATTERIES

(75) Inventors: Dominique Plee, Lima (PE); Bernard Lestriez, Vigoulet Auzil (FR); Sabrina Desaever, Pontoise (FR); Dominique Guyomard, Sautron (FR)

(73) Assignees: Centre National De La Recherche Scientifique, Paris Cedex (FR); Arkema France, Colombes (FR)

(21) Appl. No.: 13/256,522

(22) PCT Filed: Mar. 18, 2010
(86) PCT No.: PCT/FR10/50485

§ 371 Date: Oct. 12, 2011

(30) Foreign Application Priority Data
Mar. 19, 2009 (FR) 0901279

(51) Int. Cl. H01M 4/136; H01B 1/24; H01M 4/36; H01M 4/139

(52) U.S. Cl. 429/211; 427/77; 427/78; 264/320; 252/507; 252/508; 252/509; 252/506; 252/511

(57) ABSTRACT

The present invention relates to a positive electrode composite material for Li-ion battery, to the preparation method thereof, and to the use thereof in a Li-ion battery. The composite material according to the invention includes: a) at least one conductive additive including carbon nanotubes at a content between 1 and 2.5 wt %, preferably between 1.5 and 2.2 wt %, relative to the total weight of the composite material; b) an active electrode material capable of reversibly forming an insertion compound with lithium, having an electrochemical potential greater than 2V relative to the Li/Li⁺ couple, and selected from among compounds having LiMv(XOz)n polyanionic framework; and c) a polymer binder. The positive electrode composite material according to the invention imparts, to the Li-ion battery incorporating said electrode, high support for the cycling capacity, weak internal resistance, and strong charge and discharge kinetics for the moderate cost of the stored KW.

The invention relates generally to the field of the storage of electrical energy in secondary lithium batteries of Li-ion type. More specifically, the invention relates to a material for the positive electrode of an Li-ion battery, to its method of preparation and to its use in an Li-ion battery. Another subject matter of the invention is the Li-ion batteries manufactured by incorporating this composite electrode material.

The electrode material according to the invention can be used in a secondary Li-ion battery comprising a nonaqueous electrolyte, on which it confers excellent characteristics of capacity and cycling under high current density.

An Li-ion battery comprises at least one negative electrode or anode coupled to a current collector made of copper, a positive electrode or cathode coupled to a current collector made of aluminum, a separator and an electrolyte. The electrolyte is composed of a lithium salt, generally lithium hexafluorophosphate, mixed with a solvent which is a mixture of organic carbonates which are chosen in order to optimize the transportation and the dissociation of the ions. A high dielectric constant promotes the dissociation of the ions and thus the number of ions available in a given volume, whereas a low viscosity promotes ion diffusion, which plays an essential role, among other parameters, in the charge and discharge rates of the electrochemical system.

An electrode generally comprises at least one current collector on which is deposited a composite material which is composed of: an “active” material, as it exhibits an electrochemical activity with regard to lithium, a polymer, which acts as binder and which is generally a vinylidene fluoride copolymer for the positive electrode and aqueous-based binders, of carboxymethylcellulose type, or styrene-butadiene latexes for the negative electrode, plus an additive which conducts electrons, which is generally carbon black Super P or acetylene black.

During charging, lithium is inserted into the active material of the negative electrode (anode) and its concentration is kept constant in the solvent by the extraction of an equivalent amount of the active material of the positive electrode (cathode). The insertion into the negative electrode is reflected by a reduction of the lithium and it is therefore necessary to contribute, via an external circuit, the electrons to this electrode originating from the positive electrode. At discharge, the reverse reactions take place.

The conventional active materials are graphite at the negative electrode and cobalt oxide at the positive electrode.

Li-ion batteries are used today above all in the fields of mobile phones, computers and lightweight equipment but a few niche markets exist, such as the space industry, aeronautical industry and defense applications.

Considerations with regard to the influence of anthropogenic CO₂ on climate warming and the need to reduce the consumption of fossil fuels are bringing about a very great revival of interest in electric and/or hybrid vehicles. On this account, systems for the storage of electricity, in particular batteries and supercapacitors, have numerous advantages.

Outside the transportation sector, electrochemical storage appears a method of choice in making possible optimum use and optimum management of the production of energy by the intermittent renewable energy sources which are solar power and wind power.

Among the systems with storage of electrochemical energy, Li-ion batteries exhibit virtually the highest energy density among rechargeable systems and are thus widely envisaged as source of electrical energy in electric vehicles and hybrid vehicles in the future, in particular those which would make it possible to directly recharge via the mains. However, Li-ion batteries retain some disadvantages, related in particular to safety (possibility of decomposition of the electrolyte and of the solvent with release of gas, risk of explosion and/or of ignition) and to the still high cost of the kWh stored, which has led to numerous studies on alternative active materials, both with the positive electrode (phosphates, various oxides, and the like) and with the negative electrode (silicon, tin, various alloys, and the like).

Cobalt oxide exhibits an advantageous voltage difference with respect to lithium, a good capacity and a very reasonable aging quality but runaway reactions can occur and be reflected by overheating, decomposition of solvent and electrolytes, indeed even explosions and fires, if the internal pressure exceeds the resistance of the casing of the battery. This characteristic renders the motor vehicle application out of the question. Furthermore, cobalt is now included among expensive materials and those of limited availability.

The tests carried out with LiNiO₂, LiMnO₂ and LiMn₂O₄ have disadvantages, either because the capacity is lower or because the aging is poor, even if, generally, the safety aspect is improved.

Mixed Ni—Co—M structures (where M=Mn, Al, and the like) have been tested, such as the multisubstituted lamellar compounds Li[NiₓCo_{y}M_{z}]O₂ and Li[NiₓCo₍₁₋₂ₓ₎Mnₓ]O₂, substituted spinels Li(Mn,M)₂O₄ and olivines LiFePO₄ having a conductive surface, the reversible specific capacity of which is limited to 200 mAh.g⁻¹. These novel materials for a positive electrode are currently incorporated in some new generation Li-ion batteries.

More specifically, iron phosphate has a good capacity by weight of the order of 160 mAh/g, scarcely inferior to that of cobalt oxide, but, in terms of performance by volume, the difference is accentuated because the density of iron phosphate is only 3.5. A second disadvantage is its low electrical conductivity and it is for this reason that it is supplied covered with a carbon-based coating.

The necessity of providing an electrical network which permeates the cathode has led some authors to propose carbon nanotubes (CNTs) as additives. These additives have a certain number of potential advantages, such as a high aspect ratio, a good electrical conductivity and good intrinsic mechanical properties, and also the ability to form a network.

The incorporation of CNT in an LiAl_{0.14}Mn_{1.86}O₄ cathode makes it possible to achieve better maintenance of the capacity as a function of the current density (Q. Lin et al., J. Electrochemical Soc., 151, (2004), A1115). However, the results are shown only for CNT levels of 7% at least, with respect to the electrode materials.

K. Sheem et al. (J. Power Sources, 158, (2006), 1425) show that CNTs, at 5% by weight with respect to the electrode materials, can contribute a better cycling performance than the carbon black Super P, with LiCoO₂ as cathode material. The same authors show, in another study (Electrochemical Solid-State Letters, 9, (3), (2006), A 126-129), that similar effects on the cycling performance and on the current density are obtained with LiNi_{0.7}Co_{0.3}O₂ as cathode material. The content of carbon nanotubes or of acetylene black is, this time, 3% with respect to the cathode.

W. Guoping et al. (Solid State Ionics, 79, (2008), 263-268) report a better performance of the cycling capacity and as a function of the current density of an LiCoO₂ cathode when the electrode comprises 3% by weight of CNT instead of 3% by weight of acetylene black or of nanofibers.

Sakamoto et al. (J. Electrochem. Soc., 149, (2002), A 26) have compared a synthesis of the active compound in the presence of CNT and an active material/nanotubes physical mixture; the authors show that, above 5% by weight, the sol-gel method gives composites which are superior in cyclability and in discharge capacity.

The use of CNT in composite materials for a positive electrode is furthermore described in various documents, in particular in the patent applications US 2008/038635, JP 2003-331838, JP 2003-092105 or JP 07-014582.

The problem of maintaining the highest possible capacity in cycling and in rapid discharges is essential for the development of hybrid and electric vehicles. The prior art cited shows that CNTs introduce improvements in comparison with carbon black or acetylene black. Nevertheless, this effect is obtained for contents which remain, in the opinion of the Applicant Company, too high, resulting in particular in excessively high costs for the batteries thus manufactured and in a decrease in the proportion of active material.

It thus appears desirable to have available a composite material for a positive electrode which confers, on the Li-ion battery incorporating this electrode, a maintenance of the capacity in cycling which is as high as possible, a low internal resistance, and charging and discharging kinetics which are as high as possible, for a moderate cost of the stored kW. Furthermore, the process for the preparation of said composite material must be reproducible, simple and easy to apply on an industrial scale.

Provision has been made, in the document JP 2008-300189, to use a system based on vanadium, in particular vanadium pentoxide V₂O₅, as active substance of a composite material of a positive electrode of an Li-ion battery in combination with an agent which conducts electrons based on carbon, such as carbon black, carbon nanotubes and a polymer binder.

The document CN 101 192 682 describes a secondary Li-ion battery comprising an anode composed of a mixture of a complex lithium oxide, such as a mixed Ni—Co—Li, Mn—Li or Mn—B—Li oxide, with carbon nanotubes as conductive agents in a portion of 0.1 to 3% by weight and a polymer binder, such as PVDF or PTFE.

The document EP 2 034 541 describes a process for the preparation of composite materials for a positive electrode of a lithium battery comprising lithium manganate, CNTs, carbon black and a fluoropolymer binder.

A description is given, in the document US 2004/160156, of a method for the preparation of an electrode for a battery comprising the preparation of a resin/CNT master batch, which is added to a dispersion of electrode active substance, the pasty mixture obtained subsequently being applied to an electrode substrate. The electrode active substance for a secondary lithium battery is preferably chosen from transition metal oxides, such as lithium cobalt oxide LiCoO₂, lithium nickel oxide LiNiO₂, lithium manganese oxide (LiMn₂O₄) or mixed oxides based on several transition metals.

There has now been found a composite material for a positive electrode of an Li-ion battery which meets the above criteria in an optimal fashion. In particular, it has proved to be entirely surprising to produce high-performance electrodes based on compounds having polyanionic frameworks with contents of conductive additive of CNT type as low as 1 to 2.5%.

Thus, according to a first aspect, the invention relates to a composite material for a positive electrode of an Li-ion battery, comprising:
a) at least one conductive additive comprising carbon nanotubes at a level ranging from 1 to 2.5% by weight, preferably from 1.5 to 2.2% by weight, with respect to the total weight of the composite material;
b) an electrode active material capable of reversibly forming a lithium insertion compound, having an electrochemical potential of greater than 2 V with respect to the Li/Li⁺ couple;
c) a polymer binder,
   characterized in that said lithium insertion compound is chosen from compounds having polyanionic frameworks of LiM_{y}(XO_{z})ₙ type, where
   M represents a metal atom comprising at least one of the metal atoms selected from the group formed by Mn, Fe, Co, Ni, Cu, Mg, Zn, V, Ca, Sr, Ba, Ti, Al, Si, B and Mo, and
   X represents one of the atoms selected from the group formed by P, Si, Ge, S and As.

Preferably, the compounds having polyanionic frameworks are mixed phosphates or silicates of lithium and of a metal atom M. More particularly, they are mixed phosphates.

Preferably, the compounds having polyanionic frameworks have a structure of masicon or olivine type.

More particularly, M is chosen from Fe, Mn or their combination.

Preferably, the lithium insertion compound is LiFePO₄.

The CNTs forming part of the structure of the composite material according to the invention have a fibrillar morphology. They generally have diameters of 10 to 50 nm, preferably of 10 to 20 nm, on average. The length of the carbon nanotubes is generally of the order of 5-15 μm but some dispersing processes may reduce it, in particular ultrasound. This conductive additive differs from the usual conductive additives, such as SP carbon, acetylene black or graphite, in a very high aspect ratio. The latter is defined as the ratio of the greatest dimension to the smallest dimension of the particles. This ratio is of the order of 30 to 1000 for CNTs, as opposed to 3 to 10 for SP carbon, acetylene black and graphite.

The CNTs play, in the electrode composite material, an important role with regard to maintaining the capacity as a function of the current density, maintaining the capacity in cycling, which allows excellent cycling stability, this being the case at high contents of active material (for example up to 94%) in the composite electrode material.

In one embodiment, the carbon nanotubes forming part of the structure of the composite material according to the invention have a content of transition metals of less than 1000 ppm by weight, measured by conventional chemical analysis, and preferably of less than 500 ppm. Excessively high contents of transition metals are believed to reduce the lifetime of the batteries, in particular at high temperature, and to increase the operating risks. However, to produce such nanotubes can prove to be expensive and can result in excessive battery manufacturing costs. The Applicant Company has found, surprisingly, that some nanotubes comprising markedly greater proportions than those mentioned above do not present problems in practice. Specifically, crude carbon nanotubes comprising residues of synthesis catalyst have proved to be entirely usable in the composite material according to the invention; they exhibit an electrochemical signature in cyclic voltammetry such that a persistence and a complete reversibility of the oxidation/reduction phenomena are observed.

In addition to the carbon nanotubes, other conductive additives can be added to the composite material: graphite, carbon black, such as acetylene black, SP carbon or carbon nanofibers. Commercial conductive additives meet this condition. Mention may in particular be made of the compounds Ensagri Super S® or Super P®, sold by Chemetals, or the VGCF nanofibers, sold by Showa Denko.

The polymer binder can be chosen from: polysaccharides, modified polysaccharides, latexes, polyelectrolytes, polyethers, polyesters, polyacrylic polymers, polycarbonates, polyimines, polyamides, polyacrylamides, polyurethanes, polyepoxides, polyphosphazenes, polysulfones, or halogenated polymers. Mention may be made, as example of halogenated polymer, of homopolymers and copolymers of vinyl chloride, of vinylidene fluoride, of vinylidene chloride, of tetrafluoroethylene or of chlorotrifluoroethylene, and copolymers of vinylidene fluoride and of hexafluoropropylene (PVDF-HFP). Mention may be made, as example, of homopolymers and copolymers of acrylamide or of acrylic acid, homopolymers and copolymers of maleic acid, homopolymers and copolymers of maleic anhydride, homopolymers and copolymers of acrylonitrile, homopolymers and copolymers of vinyl acetate and of vinyl alcohol, homopolymers and copolymers of vinylpyrrolidone, polyelectrolytes, such as the salts of the homopolymers and copolymers of vinylsulfonic acid or of phenylsulfonic acid, or homopolymers and copolymers of allylamine, of diallyldimethylammonium, of vinylpyridine, of aniline or of ethylenimine. Mention may also be made of aqueous dispersions of polymers, known as latexes, based on vinyl acetate, acrylic, nitrile rubber, polychloroprene, polyurethane, styrene/acrylic or styrene/butadiene. The term “copolymer” is understood to mean, in the present text, a polymer compound obtained from at least two different monomers. Blends of polymers are also advantageous. Mention may be made of the blends of carboxymethylcellulose with styrene/butadiene, acrylic and nitrile rubber latexes. Water-soluble polymers are particularly preferred. In particular, aqueous latexes of fluorocopolymers or fluorohomopolymers are particularly preferred.

Preferably, the polymer binder is chosen from the group: PVDF, PVDF/HFP or PVDF/PCTFE copolymers, blends of PVDF and of a PVDF comprising polar functional groups, and fluoroterpolymers.

According to a second aspect, the invention relates to a process for the preparation of an electrode composite material which comprises the following operations:
i) preparation of a suspension or dispersion comprising, in the end:
   CNTs as conductive additive;
   optionally an additional conductive additive;
   a polymer binder;
   a volatile solvent;
   an electrode active material,
   said suspension being dispersed and homogenized mechanically by ball milling, planetary milling or milling using a triple-roll mill;
ii) preparation of a film, starting from the suspension thus prepared, by any conventional means.

During the preparation of the suspension, the polymer is introduced in the pure state or in the form of a solution in a volatile solvent; the CNTs are introduced in the pure state or in the form of a suspension in a volatile solvent.

In one embodiment, the CNTs are those sold under the Graphistrength® C100 name by Arkema, exhibiting the following characteristics: the CNTs are multiwall nanotubes having from 5 to 15 walls, a mean external diameter ranging from 10 to 15 nm and a length ranging from 0.1 to 10 μm.

The carbon nanotubes are difficult to disperse. Nevertheless, by virtue of the process according to the invention, it is possible to distribute them in the electrode composite material in such a way that they form a meshwork around the particles of active material and thus play a role both of conductive additive and also of mechanical maintenance, which is important in order to accommodate the variations in volume during the charging/discharging stages. On the one hand, they provide for the delivery of the electrons to the active material particles and, on the other hand, due to their length and their flexibility, they form electrical bridges between the active material particles which move about as a result of their variation in volume. The usual conductive additives (SP carbon, acetylene black and graphite), with their relatively low aspect ratio, are markedly less effective in providing for the maintenance during the cycling of the transportation of the electrons from the current collector. This is because, with conductive additives of this type, the electrical pathways are formed by the juxtaposition of grains and the contacts between them are easily broken as a result of the expansion in volume of the particles of the active material.

The volatile solvent is an organic solvent or water or a mixture of organic solvent and of water. Mention may be made, among organic solvents, of N-methylpyrrolidone (NMP) or dimethyl sulfoxide (DMSO) or dimethylformamide (DMF).

The suspension can be prepared in a single stage or in two or three successive stages.

When the suspension is prepared in a single stage, one embodiment consists of the mixing of all the constituents, followed by the mechanical dispersing stage.

When the suspension is prepared in two successive stages, one embodiment consists in preparing a first dispersion, comprising the solvent, the CNTs and optionally all or part of the polymer binder, using mechanical means, and in then adding, to this first dispersion, the other constituents of the composite material, this new suspension being used for the preparation of the final film.

When the suspension is prepared in three successive stages: one embodiment consists in preparing a dispersion comprising the CNTs and optionally all or part of the polymer binder in a solvent, in then adding the active material, in removing the solvent in order to obtain a powder and in then forming a new suspension by adding solvent and the remainder of the constituents of the composite material to this powder, this new suspension being used for the preparation of the final film.

A preferred method for forming and homogenizing the dispersion consists in preparing a suspension of solvent, of polymer and of CNT which is subjected to the mechanical dispersing process, before the addition of the active material.

Another preferred method for forming and homogenizing the dispersion consists in preparing a suspension of solvent and of CNT which is subjected to said mechanical dispersing process, before the addition of the binders and active material.

Without the Applicant Company being committed to any one explanation, the level of performance achieved for the Li-ion battery incorporating the composite material of a positive electrode obtained according to the process of the invention results from the conditions of preparation of said material, in particular the stage of predispersing the CNTs by milling, and the quality of the dispersing, which is preferably carried out over a long period of time, generally of greater than 10 hours, which is not obvious to a person skilled in the art. Mention may be made, for example, of J.-H. Lee et al., J. Power Sources, 184, (2008), 308, who observes a deterioration in the CNTs during the dispersion thereof by ultrasound. N. Darsono et al., Mat. Chem. Phys., 110, (2008), 363, disperse CNTs by milling for two hours but an improvement in the performance for the application as electron emitters for a field emission screen does not result, as a result of the deterioration in the CNTs during the milling.

The quality of the dispersing is assessed on the basis of the values of the storage modulus G′, which is obtained by frequency rheological measurements, which measurements give access to two parameters G′ and G″, respectively storage modulus and loss modulus.

The Applicant Company has found that the value of this modulus G′ is very important with regard to the quality of the final electrode; a minimum value of 100 Pa at 1 Hz makes it possible to minimize the phenomena of polarization. Advantageously, the CNT suspension prepared according to the invention exhibits, for a frequency of 1 Hz, a storage modulus G′ as follows:
ranging from 200 to 1000 pascals, with regard to a suspension of nanotubes in NMP at 2.2% by weight,
and greater than or equal to 100 pascals, with regard to a suspension of nanotubes (at 2.2% by weight) and of PVDF (at 4.4% by weight) in NMP.

The film can be obtained from the suspension by any conventional means, for example by extrusion, by tape casting or by spray drying on a substrate, followed by drying. In the latter case, it is advantageous to use, as substrate, a metal sheet capable of acting as collector for the electrode, for example an aluminum sheet or grid treated with a corrosion-resistant coating. The film on a substrate thus obtained can be used directly as electrode.

This film can optionally be made denser by application of a pressure (between 0.1 and 10 tonnes/cm²).

The composite material according to the invention is of use in the preparation of electrodes for electrochemical devices, in particular in lithium batteries.

Another subject-matter of the invention is composed of a positive electrode of an Li-ion battery comprising at least one current collector on which is deposited a composite material according to the invention or obtained according to the process of the invention.

Another subject matter of the invention consists of an Li-ion battery incorporating said positive electrode.

A lithium battery comprises a negative electrode, composed of lithium metal, a lithium alloy or a lithium insertion compound, and a positive electrode, the two electrodes being separated by a solution of a salt, the cation of which comprises at least one lithium ion, such as, for example, LiPF₆, LiAsF₆, LiClO₄, LiBF₄, LiC₄BO₈, Li(C₂F₅SO₂)₂N, Li[(C₂F₅)₃PF₃], LiCF₃SO₃, LiCH₃SO₃, LiN(SO₂CF₃)₂, LiN(SO₂F)₂, and the like, in an aprotic solvent (ethylene carbonate, propylene carbonate, dimethyl carbonate, diethyl carbonate, methyl carbonate, and the like), the combined mixture acting as electrolyte.

The positive electrode is composed of the composite material, the active substance of which represents from 80% to 97%. The content of polymeric binder is between 0.1 and 10% and the content of carbon nanotubes is between 1% and 2.5% by weight, preferably between 1.5% and 2.2% by weight, of the weight of the dry electrode.

The invention also relates to the use of a composite material comprising:
a) at least one conductive additive comprising carbon nanotubes at a level ranging from 1 to 2.5% by weight, preferably from 1.5 to 2.2% by weight, with respect to the total weight of the composite material;
b) an electrode active material capable of reversibly forming a lithium insertion compound, having an electrochemical potential of greater than 2 V with respect to the Li/Li⁺ couple, said lithium insertion compound being chosen from the compounds having polyanionic frameworks of LiM_{y}(XO_{z})ₙ type, where:
   M represents a metal atom comprising at least one of the metal atoms selected from the group formed by Mn, Fe, Co, Ni, Cu, Mg, Zn, V, Ca, Sr, Ba, Ti, Al, Si, B and Mo, and
   X represents one of the atoms selected from the group formed by P, Si, Ge, S and As,
c) a binder composed of a polymer or a blend of polymer binders.

The invention also relates to the use of a composite material obtained according to the process described above in the manufacture of Li-ion batteries.

The present invention is illustrated by the following examples, to which it is not, however, limited.

### EXAMPLE 1

The composite material is composed of 94% by weight of C/LiFePO₄ with a carbon coating, the latter representing 1-3% of the total weight of C/LiFePO₄, of 4% by weight of the PVDF binder supplied by Arkema under the Kynar® brand, ⅓ of which is composed of Kynar® ADX and ⅔ of which is composed of Kynar® HSV 900, and of 2% by weight of CNTs supplied by Arkema under the name Graphistrength® C100. These nanotubes have a mean diameter of 20 nm and a length estimated at a few microns and their chemical composition shows that they comprise approximately 7% of inorganic ash resulting from the synthesis process. The synthesis protocol followed in order to prepare the C/LiFePO₄ composite is described by J-F. Martin et al., Electrochem. Solid-State Letters, 2008, Vol. 11, No. 1, pp. A12-A16. A conductive carbon (Lion, ECP Ketjetblack) is added to the precursors Li₂CO₃ (Wako, 99%), Fe(II) C₂O₄.2H₂O (Aldrich, 99%) and (NH₄)₂HPO₄ (Wako, 99%) so that it represents 1-3% of the total final weight of C/LiFePO₄. The mixture is comilled in a jar made of chromium stainless steel with a volume of 250 ml, containing a mixture of beads made of chromium stainless steel with a diameter of 10 and 5 mm, by a planetary mill for 24 h. After drying at 120° C., the mixture is treated at 600° C. for 6 h in an atmosphere of argon (with 2% of H₂).

In a first stage, all of the CNTs participating in the composition of the composite material are first of all dispersed in NMP using a bead mill (Pulverisette 7, Fritsch). The conditions of the dispersing are 700 revolutions/minute and a 12.5 ml milling chamber containing three beads with a diameter of 10 mm, 0.360 ml of NMP and 8 mg of CNT. The duration of the dispersing varies from 6 to 48 h.

In a second stage, the C/LiFePO₄ particles (376 mg), 16 mg of PVDF and 0.640 ml of NMP are added to the dispersion of the CNTs and everything is mixed by comilling at 700 revolutions/minute for 1 h 30. The composite material constitutes 29% by weight of the suspension, the remainder being NMP.

In a third stage, the electrode is prepared by coating the suspension comprising the composite onto a current collector made of aluminum with a thickness of 25 μm. The height of the scraper of the coating machine is set at 180 μm. The electrode is dried overnight in an oven at 70° C. It is then made dense under 62.5 MPa. It is subsequently again dried in an oven at 70° C. overnight and finally at 100° C. under vacuum for 1 h. After drying, the amount of electrode deposited per unit of surface area of current collector is measured: 4 mg/cm².

The electrode thus obtained was fitted to a battery having, as negative electrode, a sheet of lithium metal rolled onto a current collector made of nickel, a separator made of fiber glass and a liquid electrolyte composed of a 1M solution of LiPF₆ dissolved in a 1:1 mixture of ethylene carbonate and dimethyl carbonate (EC/DMC).

The evaluation of the electrochemical performance was carried out in the potential range 2-4.3 V vs. Li⁺/Li, in galvanostatic mode. A current I of 1 A/g corresponds to a 6C rate (duration of charging or discharging 10 minutes).

The appended FIG. 1 represents the change in the capacity Q (in mAh/g) at a 6C rate (1 A/g) as a function of the duration of the dispersing of the CNTs. The best electrochemical performance is obtained for an optimum dispersing time of 15 h.

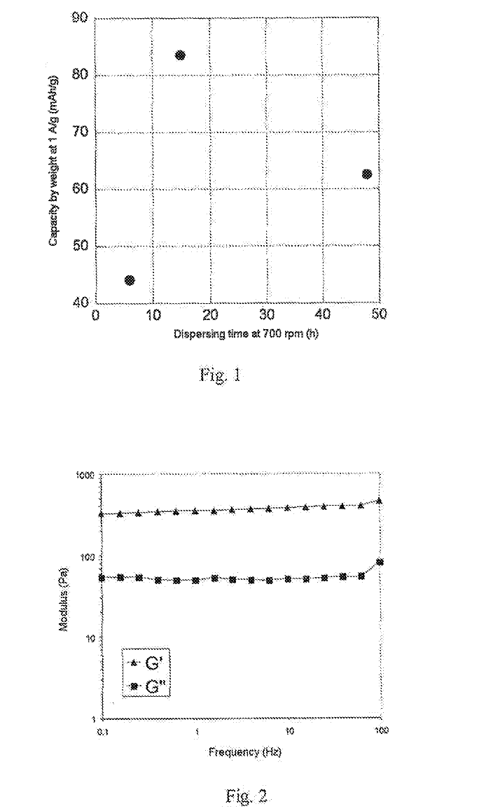

The appended FIG. 2 gives the rheological characteristics of the CNT dispersion after milling for 15 h. For a solids content of CNT of 8 mg in 0.360 ml of NMP, an optimum electrochemical performance is obtained when the storage module G′ reaches a value of at least 250 Pa in the frequency range 0.1 to 100 Hz.

### EXAMPLE 2

The composition of the composite material of this example is identical to that of example 1. The preparation differs from that given in example 1 in that the PVDF binder is introduced, in the powder form, during the first stage, that is to say during the dispersing of the CNTs.

During the first stage, all of the CNTs and of the PVDFs participating in the composition of the composite material are first of all dispersed in NMP using a bead mill (Pulverisette 7, Fritsch). The conditions of the dispersing are 700 revolutions/minute and a 12.5 ml milling chamber containing three beads with a diameter of 10 mm, 0.360 ml of NMP, 8 mg of CNT and 16 mg of PVDF. The duration of the dispersing varies from 6 to 48 h.

During the second stage, the C/LiFePO₄ particles (376 mg) and 0.640 ml of NMP are added and everything is mixed by comilling at 700 revolutions per minute for 1 h 30. The composite material constitutes 29% by weight of the suspension, the remainder being NMP.

The electrode and the battery are subsequently prepared and the electrochemical performance is evaluated as in example 1.

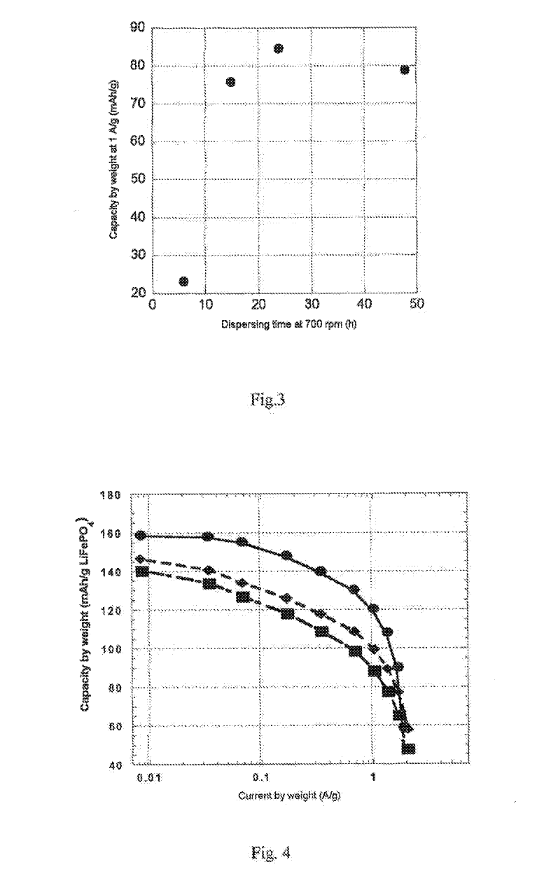

FIG. 3 represents the change in the capacity Q (in mAh/g) at a 6C rate as a function of the duration of the dispersing of the CNT+PVDF mixture. The best electrochemical performance is obtained for an optimum dispersing time of 24 h.

### EXAMPLE 3

The composition of the composite material of this example is identical to that of example 1. The preparation differs from that given in example 1 in the following characteristics: during the first stage, the duration of the dispersing of the CNTs is 15 h; during the second stage, the composite material constitutes 32% by weight of the suspension; and, during the third stage, the height of the scraper is set at 300 μm and the densifying pressure is 750 MPa. After the third stage, the amount of electrode deposited per unit of surface area of current collector is measured: 7 mg/cm².

The electrode (a) thus obtained was fitted to a battery having, as negative electrode, a sheet of lithium metal rolled onto a current collector made of nickel, a separator made of fiber glass and a liquid electrolyte composed of a 1M solution of LiPF₆ dissolved in 1:1 EC/DMC.

The electrochemical performance was measured and compared with those of similar batteries in which the positive electrode is an electrode having the following initial composition:
(b) 91.2% of C/LiFePO₄, 3.8% of PVDF and 5% of acetylene black,
(c) 91.4% of C/LiFePO₄, 3.6% of PVDF and 5% of carbon nanofibers (reference VGCF from Showa Denko).

The amount of electrode deposited per unit of surface area of current collector is 7 mg/cm² for (b) and (c).

FIG. 4 represents the change in the capacity Q (in mAh/g) as a function of the current by weight. The correspondence between the two curves and the samples is as follows:

Curve ----: sample a according to the invention
Curve -♦--♦-: comparative sample b
Curve -▪--▪-: comparative sample c

The comparison of the curves shows better maintenance of the capacity as a function of the current density for the electrode according to the invention. The capacity restored at a 6C rate is 120 mAh/g of C/LiFePO₄ with the CNTs, 100 mAh/g with the acetylene black and 85 mAh/g with the VGCFs. When the restored capacity is related to the weight of electrode, the following results are obtained: 113 mAh/g of electrode with the CNTs, 91 mAh/g with acetylene black and 78 mAh/g with the VGCFs, which demonstrate the superiority of the electrode (a) according to the invention.

### EXAMPLE 4

The composition of the composite material of this example is 94.3% of C/LiFePO₄, 1.7% of CNT and 4% of PVDF. The material was prepared in the same way as the material of example 3.

The electrode (a) thus obtained was fitted to a battery having, as negative electrode, a sheet of lithium metal rolled onto a current collector made of nickel, a separator made of fiber glass and a liquid electrolyte composed of a 1M solution of LiPF₆ dissolved in 1:1 EC/DMC.

The electrochemical performance was measured and compared with those of similar batteries in which the positive electrode is an electrode having the following initial composition:
(b) 91.2% of C/LiFePO₄, 3.8% of PVDF and 5% of acetylene black;
(c) 91.4% of C/LiFePO₄, 3.6% of PVDF and 5% of carbon nanofibers (reference VGCF from Showa Denko).

FIG. 5 represents the change in the capacity Q (in mAh/g) as a function of the cycle number for the three samples (a), (b) and (c). The charge current by weight corresponds to a C rate and the discharge current by weight corresponds to a 2C rate.

The correspondence between the two curves and the samples is as follows:

Curve ----: sample a according to the invention
Curve -♦--♦-: comparative sample b
Curve -▪--▪-: comparative sample c

The comparison of the curves shows better maintenance of the capacity as a function of the cycling for the electrode according to the invention.

### EXAMPLE 5

The composition of the composite material of this example is 94.3% of C/LiFePO₄, 1.7% of CNT and 4% of PVDF. The material was prepared in the same way as the material of example 4, except for one difference, namely that the CNTs were purified so as to reduce the iron content. After treatment, this content was found to be 215 ppm.

The electrode (a′) thus obtained was fitted to a battery having, as negative electrode, a sheet of lithium metal rolled onto a current collector made of nickel, a separator made of fiber glass and a liquid electrolyte composed of a 1M solution of LiPF₆ dissolved in 1:1 EC/DMC.

The electrochemical performance was measured and compared with those of similar batteries in which the positive electrode is an electrode having the following initial composition:
(b) 91.2% of C/LiFePO₄, 3.8% of PVDF and 5% of acetylene black;
(c) 91.4% of C/LiFePO₄, 3.6% of PVDF and 5% of carbon nanofibers (reference VGCF from Showa Denko).

Table 1 below shows the comparison in performances for the four systems, in initial and final capacities.

TABLE 1

| | Initial capacity | Capacity after 400 |
|---|---|---|
| Systems tested | (mAh/g) | cycles (mAh/9) |
| 1.7% crude CNTs | 110 | 94 |
| 1.7% treated CNTs | 115 | 107 |
| (215 ppm of iron) | | |
| 5% of acetylene black | 112 | 44 |
| 5% of VGCF | 98 | 80 |

The comparison of the figures shows better maintenance of the capacity as a function of the cycling for the electrode incorporating purified nanotubes according to the invention than for all the other additives tested.

### EXAMPLE 6

The composition of the composite material of this example is similar to that of examples 1 to 3, 94% of C/LiFePO₄, 2% of CNT and 4% of PVDF. It is prepared as follows: all of the CNTs participating in the composition of the composite material are first of all dispersed in NMP. On conclusion of the dispersing, C/LiFePO₄ particles and NMP are added and everything is mixed by comilling. The NMP is subsequently removed by drying and the powder obtained is recovered. It is subsequently dispersed in a solution of PVDF in NMP.

In a first stage, all of the CNTs participating in the composition of the composite material are first of all dispersed in NMP using a bead mill (Pulverisette 7, Fritsch). The conditions of the dispersing are 700 revolutions/minute for 15 hours and a 12.5 ml milling chamber containing three beads with a diameter of 10 mm, 0.360 ml of NMP and 9.6 mg of CNT.

In a second stage, the C/LiFePO₄ particles (447.4 mg) and 0.640 ml of NMP are added to the dispersion of the CNTs and everything is mixed by comilling at 700 revolutions per minute for 1 h 30.

In a third stage, the suspension is dried in an oven at 70° C. overnight, on conclusion of which a powder is recovered composed of 2.1% by weight of CNT and 97.9% by weight of C/LiFePO₄.

In a fourth stage, this powder and 19 mg of PVDF are dispersed in 1 ml of NMP by comilling at 700 revolutions per minute for 1 h 30. The composite material constitutes 32% by weight of the suspension, the remainder being NMP.

In a fifth stage, the electrode is prepared by coating the suspension comprising the composite onto a current collector made of aluminum with a thickness of 25 μm. The height of the scraper of the coating machine is set at 300 μm. The electrode is dried in an oven at 70° C. overnight. It is then made dense under 750 MPa. It is subsequently again dried in an oven at 70° C. overnight and finally at 100° C. under vacuum for 1 h. After drying, the amount of electrode deposited per unit of surface area of current collector is measured: 9 mg/cm².

The electrode thus obtained was fitted to a battery having, as negative electrode, a sheet of lithium metal rolled onto a current collector made of nickel, a separator made of glass fiber and a liquid electrolyte composed of a 1M solution of LiPF₆ dissolved in 1:1 EC/DMC.

The evaluation of the electrochemical performance was carried out in the potential range 2-4.3 V versus Li⁺/Li.

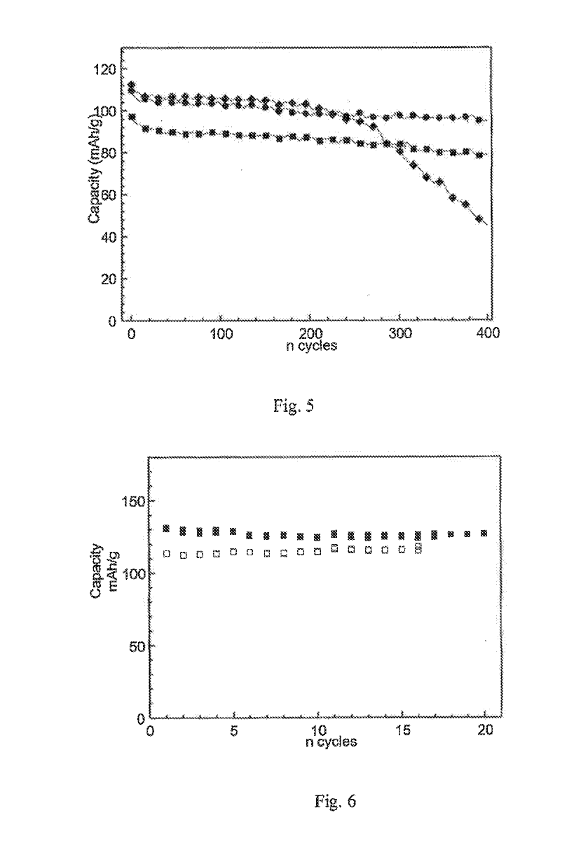

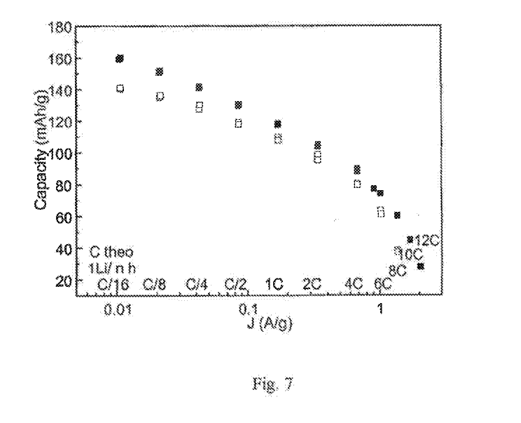

FIG. 6 represents the change in the capacity Q (in mAh/g) as a function of the cycle number at a C/5 rate and, in discharge, at a D/2.5 rate. FIG. 7 represents the change in the capacity Q (in mAh/g) as a function of the current by weight. It is observed that the composite material according to the invention exhibits a good electrochemical performance.

The correspondence between the two curves and the samples is as follows:

Curve -□-: sample according to the invention of example 6
Curve -▪-: sample according to the invention of example 7

### EXAMPLE 7

The composition of the composite material of this example is 94% C/LiFePO₄, 2% CNT and 4% of a mixture of carboxymethylcellulose (CMC) and styrene/butadiene (SBR).

In a first stage, all of the CNTs participating in the composition of the composite material are first of all dispersed in NMP using a bead mill (Pulverisette 7, Fritsch). The conditions of the dispersing are 700 revolutions/minute for 15 hours and a 12.5 ml milling chamber containing three beads with a diameter of 10 mm, 0.360 ml of NMP and 9.6 mg of CNT.

In a second stage, the C/LiFePO₄ particles (447.4 mg) and 0.640 ml of NMP are added to the dispersion of the CNTs and everything is mixed by comilling at 700 revolutions per minute for 1 h 30.

In a third stage, the suspension is dried in an oven at 70° C. overnight, on conclusion of which a powder is recovered composed of 2.1% by weight of CNT and 97.9% by weight of C/LiFePO₄.

In a fourth stage, this powder and 19 mg of CMC+SBR are dispersed in 1 ml of deionized water by comilling at 700 revolutions per minute for 1 h 30. The composite material constitutes 32% by weight of the suspension, the remainder being deionized water.

In a fifth stage, the electrode is prepared by coating the suspension comprising the composite onto a current collector made of aluminum with a thickness of 25 μm. The height of the scraper of the coating machine is set at 300 μm. The electrode is dried at ambient temperature overnight. It is then made dense under 750 MPa. It is subsequently dried at 100° C. under vacuum for 1 h. After drying, the amount of electrode deposited per unit of surface area of current collector is measured: 6 mg/cm².

The electrode thus obtained was fitted to a battery having, as negative electrode, a sheet of lithium metal rolled onto a current collector made of nickel, a separator made of glass fiber and a liquid electrolyte composed of a 1M solution of LiPF₆ dissolved in 1:1 EC/DMC.

The evaluation of the electrochemical performance was carried out in the potential range 2-4.3 V vs. Li⁺/Li.

FIG. 6 represents the change in the capacity Q (in mAh/g) as a function of the cycle number at a C/5 rate and, in discharge, at a D/2.5 rate. FIG. 7 represents the change in the capacity Q (in mAh/g) as a function of the current by weight. It is observed that the composite material according to the invention exhibits a good electrochemical performance.

The correspondence between the two curves and the samples is as follows:

Curve -□-: sample according to the invention of example 6
Curve -▪-: sample according to the invention of example 7

### EXAMPLE 8

The objective of this example is to show that the nanotubes comprising residues of the synthesis catalyst do not present a problem in practice. To this end, a button cell is assembled in the following way, comprising:
at the positive terminal, 40% of crude nanotubes, the iron level of which is of the order of 3%, and 60% of PVDF coated onto aluminum at various thicknesses;
at the negative terminal, lithium metal;
as electrolyte, EC/DMC (1:1) with LiPF₆ (1M)

These batteries are subsequently cycled in cyclic voltammetry on a VMP 2 workstation between 2 and 4.3 V with respect to Li/Li⁺ and at 50 mV/h.

For 0.43 mg/cm², an oxidation peak is observed at 3.45 V and a reduction peak is observed at 3.41 V, which peaks are perfectly superimposed over 100 cycles at 20° C. The same experiment is carried out at 55° C. and a very slight displacement is observed, respectively to 3.44 V and 3.415 V, which are stable over 61 cycles.

The values of the two peaks during the cycles are combined in the following table:

TABLE 2

| | 1st | | | |
|---|---|---|---|---|
| | cycle | 40th cycle | 50th cycle | 61st cycle |
| Surface | 47 | 47 | 47 | 46 |
| area of the | | | | |
| oxidation | | | | |
| peak (μC) | | | | |
| Surface | 46 | 47 | 44 | 45 |
| area of the | | | | |
| reduction | | | | |
| peak (μC) | | | | |

It is concluded therefrom that the iron is in the stable form, that it is not dissolved in the electrolyte and that it remains present at the positive electrode. Nevertheless, it undergoes fully reversible oxidation/reduction phenomena.

1. A composite material for a positive electrode of an Li-ion battery, comprising:
a) at least one conductive additive comprising carbon nanotubes at a level ranging from 1 to 2.5% by weight, with respect to the total weight of the composite material;
b) an electrode active material capable of reversibly forming a lithium insertion compound, having an electrochemical potential of greater than 2 V with respect to the Li/Li⁺ couple;
c) a binder composed of polymer or a blend of polymers,
characterized in that said lithium insertion compound has a polyanionic frameworks of LiM_{y}(XO_{z})ₙ type, where
M represents a metal atom selected from the group consisting of Mn, Fe, Co, Ni, Cu, Mg, Zn, V, Ca, Sr, Ba, Ti, Al, Si, B and Mo; and
X represents an atoms selected from the group consisting of P, Si, Ge, S and As.

2. The composite material as claimed in claim 1, characterized in that
said lithium insertion compound comprises mixed phosphates or silicates of ithium and of a metal atom M.

3. The composite material as claimed in claim 1, characterized in that the metal M is selected from the group consisting of Fe, Mn and mixtures thereof.

4. The composite material as claimed in claim 1, further comprising an additional conductive additive, other than the carbon nanotubes, selected from the group consisting of graphite, carbon black, and carbon nanofibers.

5. The composite material as claimed in claim 1, in which said binder is selected from the group consisting of PVDF, PVDF/HFP copolymers, PVDF/CTFE copolymers, blends of PVDF, PVDF comprising polar functional groups, and fluoroterpolymers.

6. The composite material as claimed in claim 1, in which the carbon nanotubes have a content of transition metals of less than 1000 ppm by weight.

7. The composite material as claimed in claim 1, in which the carbon nanotubes exhibit an electrochemical signature in cyclic voltammetry defined by a persistence and a complete reversibility of the oxidation/reduction phenomena.

8. A process for the preparation of a composite material of a positive electrode of an Li-ion battery comprising:
i) preparing, by dispersing and homogenizing, a suspension comprising:
CNTs conductive additive;
optionally an additional conductive additive;
a polymer binder;
a volatile solvent;
an electrode active material,
ii) forming a film, from the suspension.

9. The process as claimed in claim 8, in which the CNTs are multiwall nanotubes having from 5 to 15 walls, a mean external diameter ranging from 10 to 15 nm and a length ranging from 0.1 to 10 μm.

10. The process as claimed in claim 8, in which the suspension is prepared in a single stage, consisting of mixing of all the constituents, followed by a mechanical dispersing stage.

11. The process as claimed in claim 8, in which the suspension is prepared in two successive stages, consisting of preparing a dispersion, comprising the solvent, the carbon nanotubes and optionally all or part of the polymer binder, and then adding, to this dispersion, the other constituents of the composite material.

12. The process as claimed in claim 8, in which the suspension is prepared in three successive stages: consisting of preparing a dispersion comprising the carbon nanotubes and optionally all or part of the polymer binder in a solvent, then adding the active material, then removing the solvent to obtain a powder and then forming a second suspension by adding solvent and the remainder of the constituents of the composite material to said powder.

13. The process as claimed in claim 8, in which the suspension exhibits, for a frequency of 1 Hz, a storage modulus G′ ranging from 200 to 1000 pascals, with regard to a suspension of nanotubes in NMP at 2.2% by weight.

14. The process as claimed in claim 8, in which said film is made denser by application of a pressure of between 0.1 and 10 tonnes per cm².

15. A positive electrode of an Li-ion battery comprising at least one current collector on which is deposited a composite material as claimed in claim 1.

16. An Li-ion battery incorporating at least one positive electrode as claimed in claim 15.

17. (canceled)

18. The process of claim 8, in which said dispersing and homogenizing is provided by ball milling, planetary milling or triple-roll milling.

19. The process as claimed in claim 8, in which the suspension exhibits, for a frequency of 1 Hz, a storage modulus G′ greater than or equal to 100 pascals, with regard to a suspension of nanotubes at 2.2% by weight and of PVDF at 4.4% by weight in NMP.

20. The process of claim 8, in which said film is prepared by tape casting or spray drying on a substrate, followed by drying.
